(19) United States
(12) Patent Application Publication
(10) Pub. No.: US 2014/0165791 A1
(43) Pub. Date: Jun. 19, 2014

(54) WRENCH

(71) Applicant: Chih-Hung Wu, Taichung City (TW)

(72) Inventor: Chih-Hung Wu, Taichung City (TW)

(21) Appl. No.: 13/716,818

(22) Filed: Dec. 17, 2012

(51) Int. Cl. B25B 13/06

(52) U.S. Cl. CPC B25B 13/065
USPC 81/121.1

(57) ABSTRACT

A wrench is formed with a polygonal first engaging hole that is defined by a plurality of engaging surfaces and that is adapted for engaging a head of a first bolt. Each engaging surface has a pair of plane surface portions and an intermediate surface portion interconnecting the plane surface portions and defining a groove. The grooves of the engaging surfaces collaboratively define a polygonal second engaging hale for engaging a head of a second bolt. The intermediate surface portion of each engaging surface cooperates with the corresponding plane surface portions to form two angular intersections adapted to abut respectively against side surfaces of the head of the second bolt that define a corresponding corner of the head of the second bolt.

### BACKGROUND OF THE INVENTION

1. Field of the Invention

This invention relates to a wrench, more particularly to a wrench that is adapted for fastening and unfastening bolts of different sizes.

2. Description of the Related Art

Referring to FIG. 1, a conventional wrench 10 has a main body 11 and an engaging hole 12 formed in one end of the main body 11 and having a predetermined size for engagement with a bolt (not shown) of a corresponding size.

Referring to FIG. 2, a conventional ratchet wrench 20 has a main body 21 and a ratchet member 22 disposed in one end of the main body 21 and formed with an engaging hole 23. When the engaging hole 23 is engaged with a bolt (not shown), the bolt can be driven to rotate through rotation of the main body 21 in a rotational direction. The bolt is not moved when the main body 21 is rotated in an opposite rotational direction.

Referring to FIG. 3, a socket 30 of a conventional socket wrench is formed with a polygonal engaging hole 31. One end of the socket 30 can engage a handle of the conventional socket wrench (not shown) while the other end of the socket 30 can engage a bolt through the engaging hole 31 such that the bolt can be fastened and unfastened through rotation of the handle of the conventional socket wrench.

However, the sizes of the engaging holes 12, 23, 31 of the abovementioned conventional wrenches 10, 20, 30 are fixed. One wrench can only wrench bolts with the same size. In practice, bolts are in different sizes both in Metric and Imperial systems of units, and users must carry multiple wrenches and spend more budgets purchasing wrenches with different sizes.

U.S. Pat. No. 8,056,448 B2 discloses another conventional wrench that is defined with an engaging hole in a head thereof. The engaging hole is defined by an inner surface which is formed by six concave surface segments and six convex surface segments that are alternatively connected to each other. As such, the engaging hole can be engaged with bolts of different sizes. However, when fastening and unfastening a bolt having a hexagonal head, the corners of the head contact directly and respectively the concave surface segments, which may result in wear of the corners of the head of the bolt.

Taiwanese Utility Patent No. 349458 discloses another conventional wrench having a handle and a head. Referring to FIGS. 4 and 5, the head 50 is formed with a first engaging hole 52 that is defined by a plurality of hole-defining surfaces 53. Each of the hole-defining surfaces 53 has a recessed surf ace portion 54. The recessed surface portions 54 of the hole-defining surfaces 53 cooperatively define a second engaging hole 55 that has a size different from that of the first engaging hole 52, so that this conventional wrench can fasten and unfasten bolts of different sizes. However, when a bolt 60 is fastened or unfastened with a head 61 of the bolt 60 retained in the second engaging hole 55, corners of the head 61 of the bolt 60 are engaged fittingly and respectively with the recessed surface portions 54, thereby resulting in wear of the corners of the head 61 of the bolt 60.

### SUMMARY OF THE INVENTION

Therefore, an object of this invention is to provide a wrench that is adapted for fastening and unfastening bolts of different sizes.

The wrench of this invention has a head that is formed with a polygonal first engaging hole. The first engaging hole is defined by a plurality of engaging surfaces and is adapted for engaging a head of the first bolt. Each of the engaging surfaces has a pair of spaced-apart plane surface portions and an intermediate surface portion. The intermediate surface portion interconnects the plane surface portions and defines a groove extending in a direction of a central axis of the first engaging hole. The grooves of the engaging surfaces collaboratively define a polygonal second engaging hole that is adapted for engaging a head of the second bolt with each corner of the head of the second bolt being received in the groove of a respective one of the engaging surfaces. The intermediate surface portion of each of the engaging surfaces cooperates with the plane surface portions of a corresponding one of the engaging surfaces to form two angular intersections. The angular intersections are adapted to abut respectively against side surfaces of the head of the second bolt which define a corresponding corner of the head of the second bolt so as to prevent the corresponding corner of the head of the second bolt from contacting the intermediate surface portion of a corresponding one of the engaging surfaces.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary schematic view of a conventional wrench;

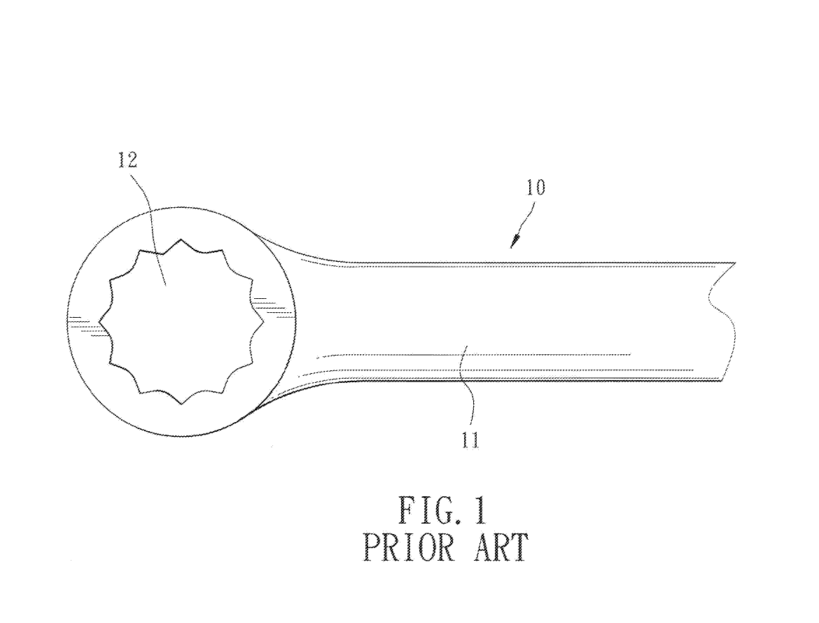

FIG. 2 is a perspective view of a conventional ratchet wrench;

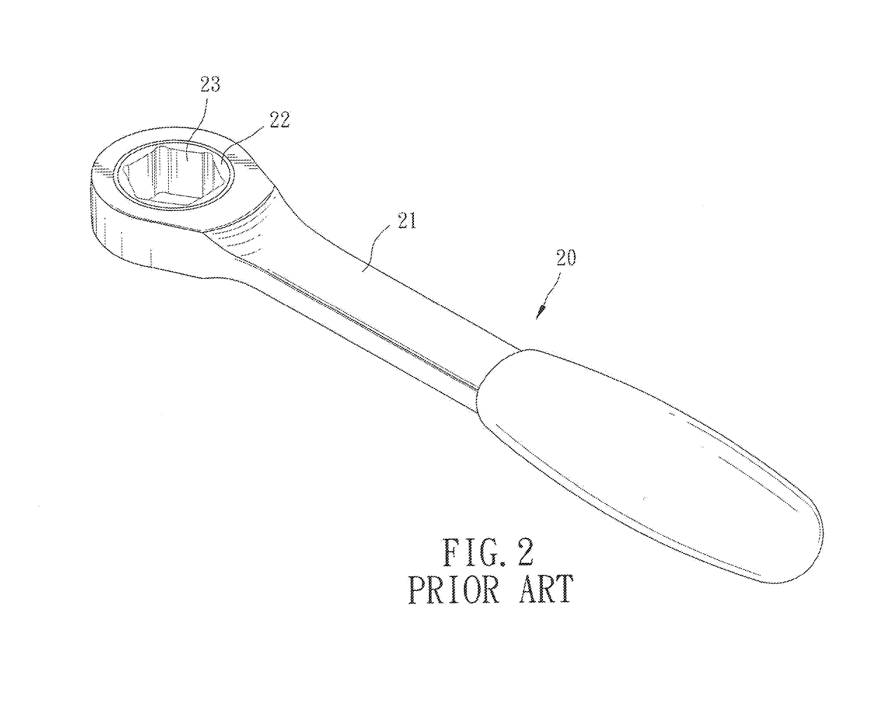

FIG. 3 is a perspective view of a socket of a conventional socket wrench;

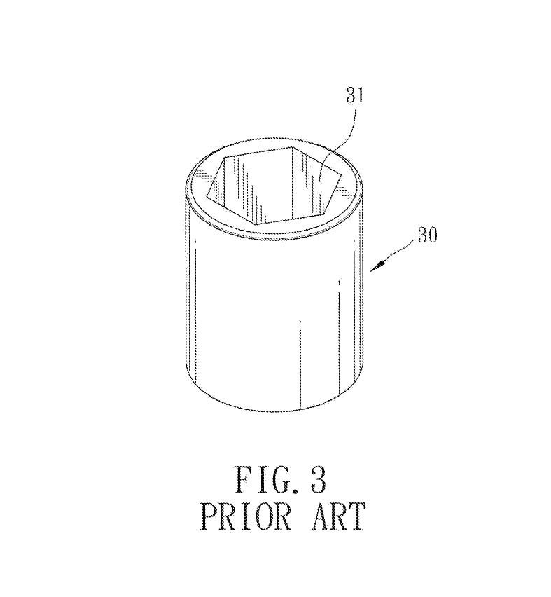

FIG. 4 is a fragmentary schematic view of another conventional wrench engaging a bolt through a first engaging hole;

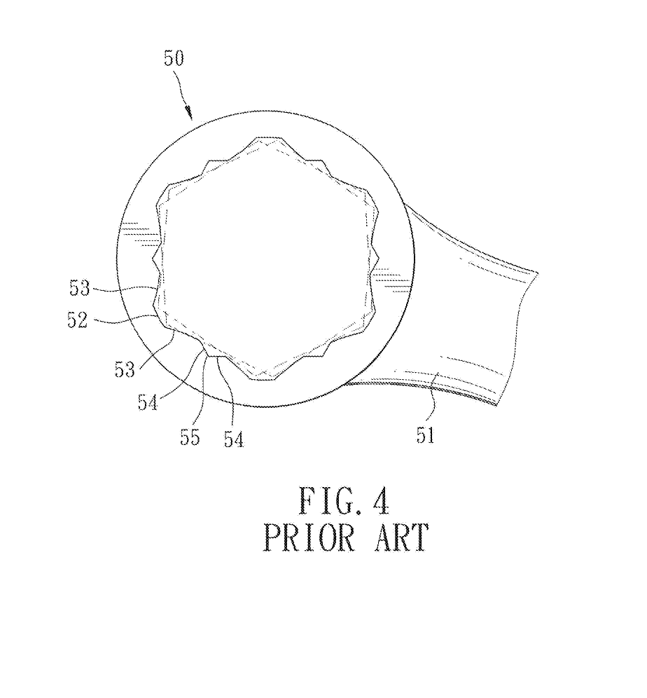

FIG. 5 is a fragmentary schematic view of the another conventional wrench engaging another bolt through a second engaging hole;

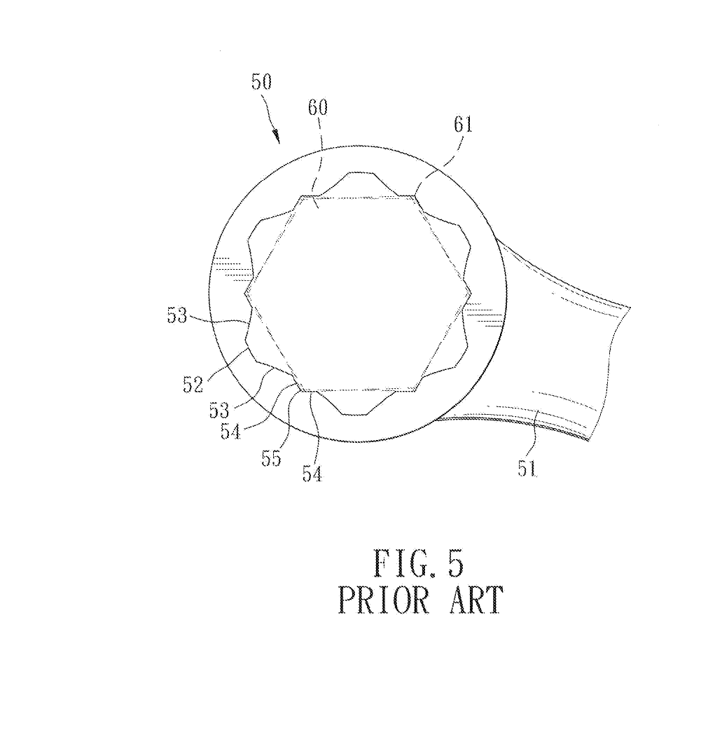

FIG. 6 is a side view of a preferred embodiment of a wrench according to this invention which is adapted for fastening and unfastening first, second and third bolts with different sizes;

FIG. 7 is a side view showing the preferred embodiment engaging the first bolt and the third bolt;

FIG. 8 is a side view showing the preferred embodiment engaging the second bolt; and

FIG. 9 is an enlarged fragmentary schematic view of the preferred embodiment.

### DETAILED DESCRIPTION OF THE PREFERRED EMBODIMENT

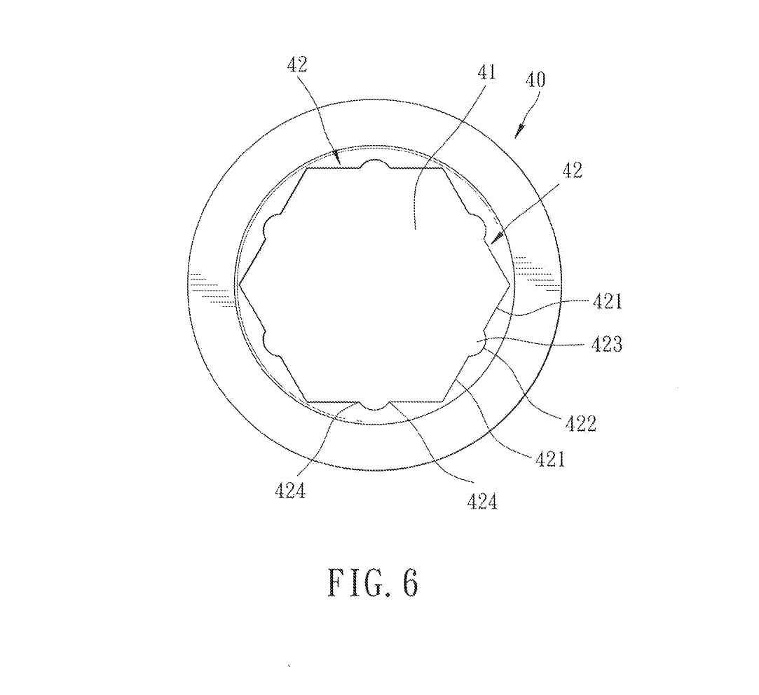

FIGS. 6 to 9 illustrate a preferred embodiment of a wrench in accordance with this invention that is adapted to fasten and unfasten first, second and third bolts 100, 200, 300 of different sizes. The wrench has a head 40 that is formed with a polygonal first engaging hole 41 defined by a plurality of engaging surfaces 42. In this embodiment, the first engaging hole 41 is a hexagonal hole and is defined by six of the engaging surfaces 42. Each of the engaging surfaces 42 has a pair of spaced-apart plane surface portions 421 and an intermediate surface portion 422. In this embodiment, the intermediate surface portion 422 is curved, interconnects the plane surface portions 421, and defines a groove 423 extending in a direction of a central axis of the first engaging hole 41. The grooves 423 in the engaging surfaces 42 collaboratively define a hexagonal second engaging hole 43. The intermediate surface portion 422 of each of the engaging surfaces 42 cooperates with the plane surface portions 421 of a corresponding one of the engaging surfaces 42 to form two angular intersections 424.

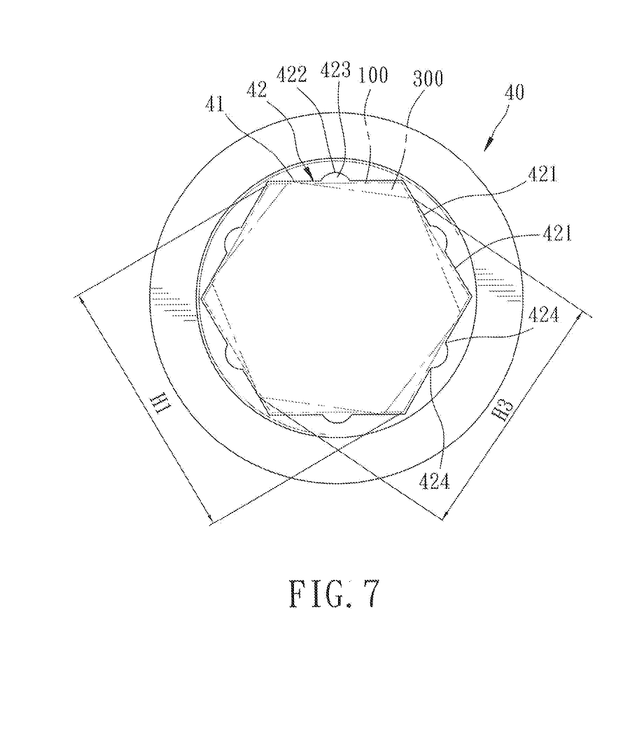

As shown, in FIG. 7, the first engaging hole 41 is adapted to engage a head of the first holt 100 having a maximum diagonal (H1), or a head of the third bolt 300 having a maximum diagonal (H3) which is slightly smaller than the maximum diagonal (H1) of the first bolt 100.

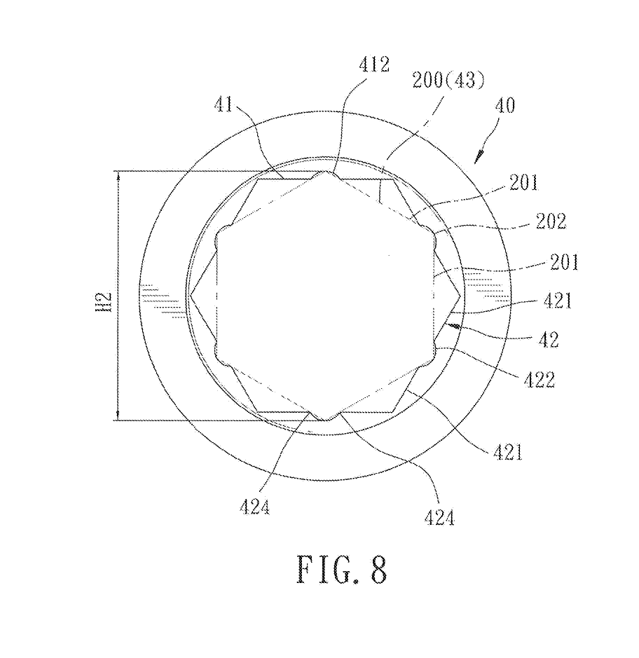

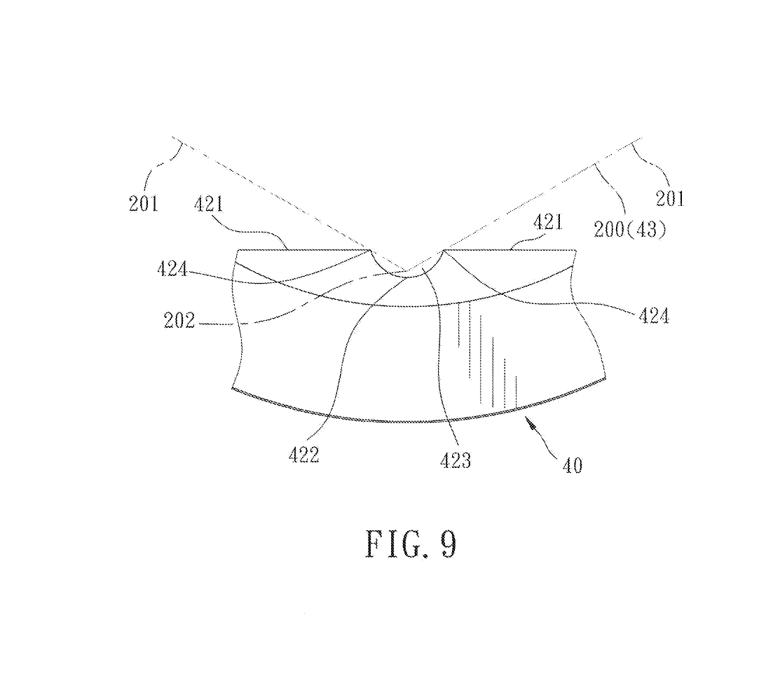

Referring to FIGS. 8 and 9, the second engaging hole 43 is adapted to engage a head of the second bolt 200 having a maximum diagonal (H2) which is significantly different from the maximum diagonals (H1, H3) of the first and third bolts 100, 300. Specifically, each corner 202 of the head of the second bolt 200 is defined by a pair of corresponding side surfaces 201 and is received in the groove 423 of a respective one of the engaging surfaces 422. When the head of the second bolt 200 is retained in the second engaging hole 43, the angular intersections 424 of each of the engaging surfaces 42 abut respectively against side surfaces 201 of each corner 202 of the head of the second bolt 200. Since each groove 423 provides a sufficient space for engaging a corresponding corner 202 of the head of the second bolt 200, the corresponding corner 202 of the head of the second bolt 200 is prevented from contacting the intermediate surface portion 422 of a corresponding one of the engaging surfaces 42 which would otherwise cause wear of the corresponding corner 202 of the head of the second bolt 200.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A wrench adapted for fastening and unfastening first and second bolts of different sizes, said wrench comprising a head formed with a polygonal first engaging hole that is defined by a plurality of engaging surfaces and that is adapted for engaging a head of the first bolt, each of said engaging surfaces having a pair of spaced-apart plane surface portions and an intermediate surface portion that interconnects said plane surface portions and that defines a groove extending in a direction of a central axis of said first engaging hole, said grooves of said engaging surfaces collaboratively defining a polygonal second engaging hole that is adapted for engaging a head of the second bolt with each corner of the head of the second bolt being received in said groove of a respective one of said engaging surfaces, said intermediate surface portion of each of said engaging surfaces cooperating with said plane surface portions of a corresponding one of said engaging surfaces to form two angular intersections that are adapted to abut respectively against side surfaces of the head of the second bolt that define a corresponding corner of the head of the second bolt so as to prevent the corresponding corner of the head of the second bolt from contacting said intermediate surface portion of a corresponding one of said engaging surfaces.

2. The wrench as claimed in claim 1, wherein said intermediate surface portion of each of said engaging surfaces is curved.
